(19) United States
(12) Patent Application Publication
(10) Pub. No.: US 2011/0120218 A1
(43) Pub. Date: May 26, 2011

(54) Hand-Held Detection Device for Determining the Height of a Material in a Container and Methods of Use

(75) Inventor: Antony S. Aldridge, Pune (IN)

(73) Assignee: Halliburton Energy Services, Inc., Duncan, OK (US)

(21) Appl. No.: 12/625,092

(22) Filed: Nov. 24, 2009

(51) Int. Cl. G01F 23/00

(52) U.S. Cl. 73/290 R

(57) ABSTRACT

According to an aspect of the invention, a hand-held detection device for determining the height of a material in a rigid-walled container from the outside of the container without accessing the interior of the container comprises: (a) means for detecting, through the wall of the container, the presence or absence of the material inside the container adjacent to the detector; (b) means for generating a first output corresponding to the presence or absence of the material inside the container adjacent to the detector, whereby the location of the surface level of the material inside the container can be determined through the wall of the container by moving the device and observing the first output; (c) means for measuring the vertical distance between the surface level of the material and a reference point associated with the container; (d) means for generating a second output corresponding to the vertical distance between the surface level of the material and the reference point; and (e) a power storage source. According to another aspect of the invention, a method for determining the height of a material in a container comprises the steps of: (a) providing the hand-held detection device; (b) positioning the detection device on the outside of the container adjacent to the surface level of the material; and (c) determining the height of the material contained in the container by using the second output. According to a further aspect of the invention, a method for calculating the volume of a material in a container is provided.

### FIELD OF THE INVENTION

The field of the invention is directed to a non-intrusive, hand-held device for use in determining the height of materials standing in a container.

### SUMMARY OF THE INVENTION

According to an aspect of the invention, a hand-held detection device is provided for determining the height of a material in a rigid-walled container from the outside of the container without accessing the interior of the container. The device comprises: (a) means for detecting, through the wall of the container, the presence or absence of the material inside the container adjacent to the detector; (b) means for generating a first output corresponding to the presence or absence of the material inside the container adjacent to the detector, whereby the location of the surface level of the material inside the container can be determined through the wall of the container by moving the device and observing the first output; (c) means for measuring the vertical distance between the surface level of the material and a reference point associated with the container; (d) means for generating a second output corresponding to the vertical distance between the surface level of the material and the reference point; and (e) a power storage source.

According to another aspect of the invention, a method is provided for determining the height of a material in a rigid-walled container from the outside of the container without accessing the interior of the container. The method comprises the steps of: (a) providing a hand-held detection device, wherein the detection device comprises: (i) means for detecting, through the wall of the container, the presence or absence of the material inside the container adjacent to the detector; (ii) means for generating a first output corresponding to the presence or absence of the material inside the container adjacent to the detector, whereby the location of the surface level of the material inside the container can be determined through the wall of the container by moving the device and observing the first output; (iii) means for measuring the vertical distance between the surface level of the material and a reference point associated with the container; (iv) means for generating a second output corresponding to the vertical distance between the surface level of the material and the reference point; and (v) a power storage source; (b) positioning the detection device on the outside of the container adjacent to the surface level of the material; and (c) determining the height of the material contained in the container by using the second output.

According to a further aspect of the invention, a method and portable apparatus is provided for determining the volume of material contained in a container from the outside of the container.

As used herein, the words “comprise,” “have,” “include,” and all grammatical variations thereof are each intended to have an open, non-limiting meaning that does not exclude additional elements or steps.

### BRIEF DESCRIPTION OF THE DRAWING

Other objects and advantages of the present invention will become more apparent to those persons having ordinary skill in the art to which the invention pertains from the following description taken in conjunction with the accompanying drawings, in which:

FIG. 1 is a diagrammatic elevation view of a container with an embodiment of the hand-held detection device positioned adjacent to the container according to the method of the present invention; and

FIG. 2 is a diagram illustrating the components of one embodiment of the hand-held detection device according to the present invention.

### DETAILED DESCRIPTION OF THE INVENTION

A variety of materials are stored in portable containers for use in oil or gas drilling and production operations. Examples of such materials include, but are not limited to, water-based liquids, oil-based liquids, emulsions, sols, foams, gels, powders, particulates (such as proppant or gravel), and acids. Typically, these containers do not have gauges for indicating the volume of material in the container.

As used herein, a “liquid” is an amorphous substance having no fixed shape but a fixed volume and having a continuous phase that tends to flow and to conform to the outline of its container when tested at a temperature of 25° C. (77° F.) and a pressure of 1 atmosphere. A heterogeneous liquid has an external phase and at least one internal phase. By contrast, a homogenous liquid does not have distinct phases. Examples of a heterogeneous liquid include, for example, a slurry or sol, which is a suspension of solid particles (such as sand) in a continuous liquid phase; an emulsion, which is a dispersion of two or more immiscible liquids where droplets of at least one liquid phase are dispersed in a continuous liquid phase of another; or a foam, which is a dispersion of gas bubbles in a continuous liquid phase. As used herein, a “material” is used broadly to mean liquids and solids such as congealed liquids, powders, particulate materials, and the like.

For purposes of describing the present inventions, a typical container 100 is illustrated. In the illustrated embodiment, the container 100 includes a bottom 103, a rigid cylindrical side wall 101, and a top wall 102. Alternatively, the container can have an open top wall or a removable top wall. The container can have a spherical, circular, elliptical, rectangular, square, or hexagonal cross section. Of course, a container that has a spherical, circular, or elliptical cross section will have only one side wall; whereas, a container that has planar walls will have multiple walls. Indeed, the container may have a discontinuous cross section, for example a cylindrical container with a funnel-shaped lower section. As will be described, the method and apparatus according to the present inventions are operative independent of the shape of the container.

Preferably, the volume of a material in the container has been determined in relation to the location of the surface level of the material with respect to one or more reference points 130. For example, if the surface level of the material in the container is determined to be two meters above the reference point 130, then the height of the material in the container can be determined, and the corresponding volume of the material in the container can be calculated.

It is often necessary to determine the height of a material in a container in order to determine the amount or volume remaining in the container. One way to determine the height of the material in a container is to observe the surface level of the material or to measure the location of the surface level from the inside of the container. When the container is sealed or contains toxic materials such as an acid, accessing the interior of the container is not possible. Often times, the height of the container is such that the person must climb up a ladder in order to look inside the container. This increases the potential for work-related accidents. Also, if the material is an acid or other noxious liquid, then the person looking inside the container can be exposed to harmful vapors. Thus, there is a need to determine the height and/or volume of a material in containers without accessing the inside of the containers.

There are a variety of devices that can be used to detect the presence or absence of liquid in a container. One type of device that can be used is a built-in sensor that is permanently mounted inside and on the bottom of the container. The sensor detects an absence of the liquid when the surface level of the liquid is below the sensor. Built-in sensors for each container are expensive to purchase because the sensor has to be resistant to damage from corrosive or caustic liquids. Also, because they are built-in, there is no way to move the sensor to a different location in the container. Further, there is no way to determine the height of the liquid.

Another type of device is an externally-mounted ultrasonic sensor. The device is attached (either clamped temporarily or permanently fixed) to the outside of the container at a specific location. The sensor is able to detect the presence or absence of liquid in the container through the wall or bottom of the container. One disadvantage is that the mounted device can only detect the presence or absence of liquid at the specific location of the device, but cannot determine the relative height of the liquid in the container. Another disadvantage is that the device cannot be moved easily from one location on the container to another location.

It is discovered that a lightweight, hand-held device can detect, through the wall of the container, the location of the surface level of a material in a container and detect and determine the height of material in the container, without requiring access to the interior of the container. The volume of the material in the container then can be determined by using the height of the material in the container and the dimensions of the container. An advantage of the device and method according to the invention is the volume of material remaining in a variety of containers can be determined using a single device without accessing the interior of the containers.

If there is any conflict in the usages of a word or term in this specification and one or more patent or other documents that may be incorporated herein by reference, then the definitions that are consistent with this specification control and should be adopted.

As used herein, “surface level” means the horizontal plane where the top of the material is located in the container. As used herein, “vertical distance” means the amount of separation in a direction parallel to gravitational force between two points, lines, planes, surfaces, or objects, and any combination of any two thereof. As used herein, the “height of the material” means the height of the surface level of the material when at rest inside of the container above the bottom of the container. As used herein, a “reference point” means a plane or fixed point on the container and those planes or fixed points associated with the container located above or below the surface level of the material.

Preferred Embodiment of the Detection Device According to Aspects of the Invention

According to an aspect of the invention, a hand-held detection device is provided for determining the height of a material in a rigid-walled container from the outside of the container without accessing the interior of the container. The device comprises: (a) means for detecting, through the wall of the container, the presence or absence of the material inside the container adjacent to the detector; (b) means for generating a first output corresponding to the presence or absence of the material inside the container adjacent to the detector, whereby the location of the surface level of the material inside the container can be determined through the wall of the container by moving the device and observing the first output; (c) means for measuring the vertical distance between the surface level of the material and a reference point associated with the container; (d) means for generating a second output corresponding to the vertical distance between the surface level of the material and the reference point; and (e) a power storage source.

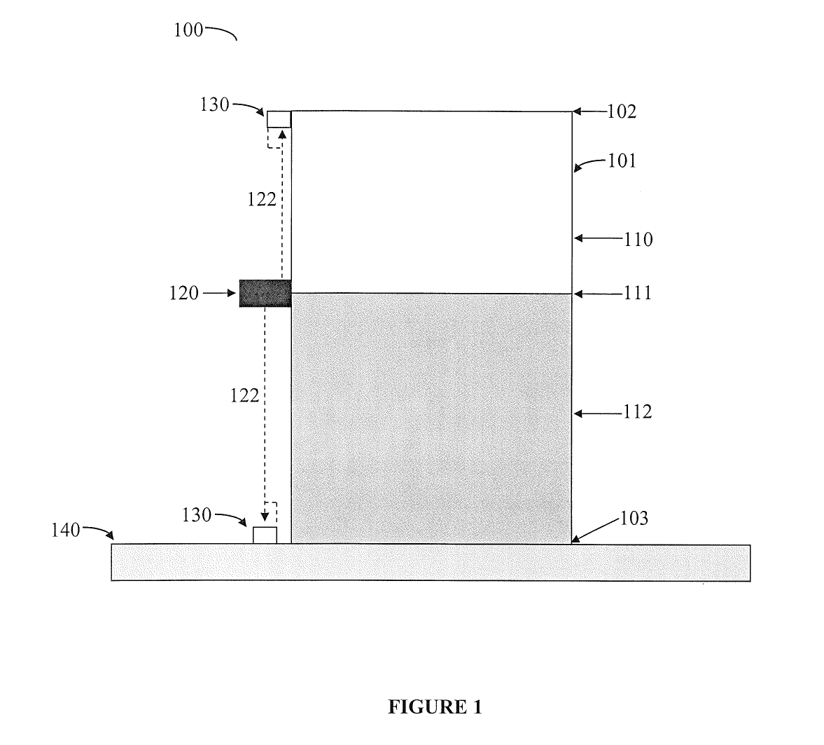

FIG. 1 is a diagram of a container 100 with a hand-held detection device 120 according to the invention positioned adjacent the wall 101. The container 100 includes a bottom 103, at least one wall 101, and a top wall 102. The bottom of the container 103 is located on a platform 140. The container 100 contains a material 112. The container can contain more than one material, for example, oil and water. The surface level of the material is identified by reference to numeral 111. In the illustrated embodiment, the top portion of the container contains a gas 110, such as air.

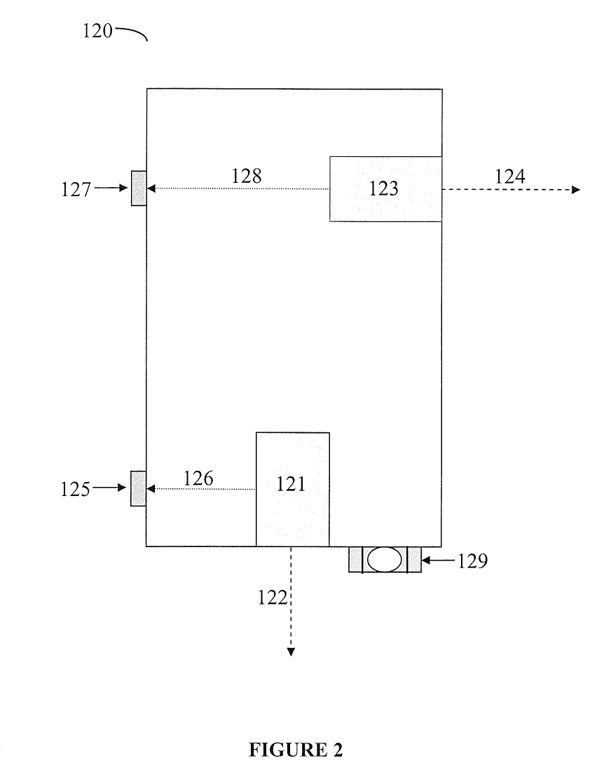

FIG. 2 is a diagram of the detection device 120 according to the invention. The means for detecting 123 can be any means that is capable of detecting the presence or absence of the material through at least one wall 101 of the container. Preferably, the detecting means detects the presence or absence via ultrasonic means. For example, the detecting means can include an ultrasonic transducer that transmits ultrasonic waves 124 and an ultrasonic wave receiver that is capable of receiving the waves. Preferably, the transducer transmits ultrasonic waves such that the waves travel along the horizontally extending plane into the container at the specific location of the transducer on the wall of the container. The detection device can include both, the transducer and the receiver, or the transducer can be located on the detection device, and the receiver can be located on the opposite wall of the container from the device. Preferably, the detection device includes both, the transducer and the receiver.

A hand-held, portable ultrasonic device for detecting the presence or absence of liquid in a tank is described in U.S. Pat. No. 4,144,517 issued to Joseph Baumoel on Mar. 13, 1979, which is hereby incorporated by reference in its entirety for all purposes. The device includes an ultrasonic circuit which includes an ultrasonic transducer which can be pressed against the outer wall of a liquid container such as a tank or pipe and which will produce an output signal which indicates whether there is a liquid in the container at the transducer location.

An ultrasound device for determining the presence or absence of liquid in a container is described in U.S. Pat. No. 7,114,390 issued to David C. Lizon, Gregory Kaduchak, and Dipen N. Sinha on Oct. 3, 2006, which is hereby incorporated by reference in its entirety for all purposes. The device includes: a transducer mounted to a wall of a container in physical contact with the outside wall of the container for generating at least two acoustic resonance responses in the liquid; a sweep generator for electrically exciting the transducer over a chosen range of acoustical frequencies with a chosen waveform; and a receiver mounted on the same wall as the transducer or on the wall opposite the transducer for determining the frequencies of the at least two resonant responses. Depending on the signal observed, the presence or absence of liquid can be determined at the transducer location.

The detection device 120 is capable of detecting the presence or absence of the material in the container when the detecting means is in direct contact with the outside wall of the container. Preferably, the detecting means 123 is small enough such that it can fit through any protective cage that may surround the wall(s) of the container and, as such, is capable of being in direct contact with the outside wall of the container.

The device 120 includes a means for generating a first output 128 corresponding to the presence or absence of the material 112 inside the container 100 adjacent to the detecting means 123. Preferably, the first output 128 is in an audible form or in a visual form. For example, when the first output is in an audible form, the device can generate a sound when the material is present; whereas, no sound will be generated if the material is absent. In this manner, an operator can move the device 120 vertically along the wall 101 of the container and listen for the sound generated in order to determine the location of the surface level of the material.

The first output 128 can also be in a visual form. The first output in visual form can either be a continuous output or a static output for a specific time. For example, the device can include a screen 127 for displaying the first output. The screen can display a continuous output of the presence or absence of the material 112. In this manner, an operator can locate the surface level of the material by monitoring the output being displayed on the screen.

The device 120 includes a means for measuring 121 the vertical distance between the surface level of the liquid 111 and a reference point 130. In one embodiment, the measuring means measures the distance by sound waves 122. Alternatively, the measuring means is light waves 122. If the measuring means is light waves, then the measuring means can be a laser. A method and an apparatus for determining distance by the use of laser beam is described in U.S. Pat. No. 4,729,653 issued to Takao Kobayashi on Mar. 8, 1988, which is incorporated by reference in its entirety for all purposes.

The location of the reference point 130 associated with the container can be predetermined. For example, the reference point can be connected or permanently fixed to the outside of the wall of the container. In the illustrated embodiment, the reference point 130 is located at the vertical height of the bottom of the wall of the container or the top of the wall of the container. By way of another example, the reference point can be connected to the outside of the wall of the container at a point substantially at the bottom or top of the wall of the container. Alternatively, the reference point 130 can be located on the ground or another location between the ground and the bottom 103 of the container (such as a platform 140 on which the container is placed). The reference point 130 need only be associated with the container such that the height and/or volume of the material in the container can be determined from the vertical distance between the surface level of the material and the reference point.

The device 120 includes a means for generating a second output 126 corresponding to the vertical distance between the surface level of the material and the reference point. In the illustrated embodiment, the second output is transmitted to a receiver 125 for receiving the output and displaying the output in a visual form. For example, the displayed output can be numbers and expressed in inches, feet, or meters. The second output 126 can be displayed as a static output. In this manner, an operator can read the static output and determine the height of the liquid in the container.

As shown in FIG. 1, the measuring means is directed vertically to measure the vertical distance between the surface level of the material and the reference point. For example, if a laser is used as the measuring means, then the laser beam emitted should be directed vertically at the reference point. The detection device can further include at least one leveling indicator 129, such that an operator can determine if the measuring means is directed vertically. The detection device 120 can include two leveling indicators 129, so that the device can be oriented vertically. In the illustrated embodiment, the leveling indicator 129 is a spirit level located on the detection device. A spirit level utilizes an air bubble and liquid inside a transparent glass or plastic tube, wherein two lines are marked on the tube. When the air bubble is positioned in between the two lines, then the detection device is considered level, and the measuring means will be directed vertically. Alternatively, the detection device can include a self-leveling mechanism such as the one described in U.S. Pat. No. 5,900,931 issued to Joseph F. Rando on May 4, 1999, which is incorporated by reference in its entirety for all purposes.

The detection device 120 includes a power storage source. The power storage source is for storing electrical energy to power the detecting and measuring means and the first and second outputs. The power storage source can be a battery or a rechargeable battery. In this manner, the detection device 120 is portable and does not require being plugged into an external power source.

Preferred Embodiment of the Method of Use of the Detection Device

According to a second aspect of the invention, a method is provided for determining the height of a material in a rigid-walled container from the outside of the container without accessing the interior of the container. The method comprises the steps of: (a) providing a hand-held detection device, wherein the detection device comprises: (i) means for detecting, through the wall of the container, the presence or absence of the material inside the container adjacent to the detector; (ii) means for generating a first output corresponding to the presence or absence of the material inside the container adjacent to the detector, whereby the location of the surface level of the material inside the container can be determined through the wall of the container by moving the device and observing the first output; (iii) means for measuring the vertical distance between the surface level of the material and a reference point associated with the container; (iv) means for generating a second output corresponding to the vertical distance between the surface level of the material and the reference point; and (v) a power storage source; (b) positioning the detection device on the outside of the container adjacent to the surface level of the material; and (c) determining the height of the material contained in the container by using the second output.

The method includes the step of positioning the detection device 120 on the outside of the container 100 adjacent to the surface level of the material 111 by moving the device and observing the first output 128. The detection device can be positioned on the outside of the wall of the container using hand pressure. The detection device 120 is capable of being positioned on the outside of the wall via an operator standing on the ground or a platform and extending the operator's arm above the operator's head. The detection device 120 can be attached to an extender, such as a metal or wooden pole, in order to extend the height at which the detection device can be positioned on the outside of the wall of the container. The detection device 120 is positioned on the outside of the wall of the container such that the detecting means 123 directly contacts the outside of the wall 101 of the container.

Once the detection device 120 is positioned on the outside of the wall 101 of the container, if the material is present, then the first output will indicate the presence of material at the specific location of the detection device on the wall of the container. In order to determine the surface level 111 of the material 112, the operator moves the detection device to a different vertical location on the outside of the wall of the container, and observing the first output 128 corresponding to the presence or absence of the material, determines the location on the wall of the container at which the material is absent. The operator then continues to move the detection device 120 vertically along the outside of the wall, until the first output changes from indicating an absence of the material to indicating the presence of the material. The location at which the output changes is the surface level 111 of the material 112. There may be more than one material in the container. For example, there may be oil and water in the container. The detection device 120 can also be used to determine the surface level 111 of each of the materials in the container. For example, the detecting means 123 can detect the presence or absence of the first material and generate a first output 128, and can detect the presence or absence of the second material and generate a different first output. The surface level of each of the two materials can be located by observing the two first outputs.

Once the operator positions the detection device 120 on the outside of the container adjacent to the surface level 111 of the material 112, the method, preferably, further includes the step of maintaining the detection device adjacent to the surface level of the material for a desired amount of time. The desired amount of time is the time necessary to obtain the second output corresponding to the vertical distance between the surface level of the material and the reference point.

The method can further include the step of activating the means for measuring 121 the vertical distance between the surface level of the material and the reference point. For example, the detection device can include a button or switch, which can be pressed or flipped by the operator to activate the measuring means. In this manner, the vertical distance can be measured. Most preferably, the measuring means is a laser.

The detection device can include a leveling indicator 129 for indicating if the measuring means is directed vertically at the reference point. If the device includes a leveling indicator, then the method can further include the step of determining if the measuring means is directed vertically at the reference point by using the leveling indicator. For example, if the leveling indicator is a spirit level, then the operator can look at the spirit level in order to determine whether the measuring means is directed vertically. If the spirit level indicates the measuring means is not directed vertically, then the operator can use the leveling indicator in order to align the measuring means vertically with the horizontal plane of the reference point.

As illustrated above, the reference point 130 can be located at the bottom of the wall of the container, the top of the wall of the container, substantially at the bottom or top of the wall of the container, the ground, or another reference point between the ground and the bottom of the container (such as a platform 140 on which the container may be placed). If the reference point is located at the bottom of the wall of the container, then the second output is the height of the material. If the reference point is located at the top of the wall, the ground, or another reference point, then the method can further include the step of calculating the height of the material in the container. For example, if the reference point is located at the top of the wall of the container, then the height of the material can be calculated by subtracting the second output (the vertical distance between the surface level 111 of the material and the top of the wall of the container) from the total height of the container. By way of another example, if the reference point is the ground, then the height of the material can be calculated by subtracting the second output (the vertical distance between the surface level of the material and the ground) from the vertical distance between the ground and the bottom 103 of the container. In a similar fashion, if the reference point is some other point below the bottom of the container, such as a platform 140 on which the container is supported, then the height can be calculated by subtracting the second output from the vertical distance between the reference point and the bottom of the container.

According to a further aspect of the invention, a method of calculating the volume of material in the container is provided. The step of calculating is performed after the step of determining the height of the material in the container. For example, the volume can be calculated by taking into account the height of the material and the specific dimensions of the container. Some of the specific dimensions include the shape of the container and the diameter, radius, width, and length of the container. For example, the volume of a cylindrical container can be calculated as: V=π*r²*h (where r=the radius of the container and h=the height of the material). By way of another example, the volume of a rectangular- or square-shaped container can be calculated as: V=l*w*h (where l=the length of the bottom of the container, w=the width of the bottom of the container, and h=the height of the material). Alternatively, a volume-height relationship for the specific container could be determined previously by testing.

By being able to determine the volume of material remaining in the container quickly and accurately, an operator can determine the estimated time that the container will need to be re-filled based on the volume of the material remaining and the rate at which the material is being pumped out of the container.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified, and all such variations are considered within the scope and spirit of the present invention. While compositions and methods are described in terms of “comprising,” “containing,” or “including” various components or steps, the compositions and methods can also “consist essentially of” or “consist of” the various components and steps. Also, the terms in the claims have their plain, ordinary meaning unless otherwise explicitly and clearly defined by the patentee. Moreover, the indefinite articles “a” or “an”, as used in the claims, are defined herein to mean one or more than one of the elements that it introduces.

What is claimed is:

1. A hand-held detection device for determining the height of a material in a rigid walled container from the outside of the container without accessing the interior of the container, the device comprising:
(a) means for detecting, through the wall of the container, the presence or absence of the material inside the container adjacent to the detector;
(b) means for generating a first output corresponding to the presence or absence of the material inside the container adjacent to the detector, whereby the location of the surface level of the material inside the container can be determined through the wall of the container by moving the device and observing the first output;
(c) means for measuring the vertical distance between the surface level of the material and a reference point associated with the container;
(d) means for generating a second output corresponding to the vertical distance between the surface level of the material and the reference point; and
(e) a power storage source.

2. The device according to claim 1, wherein the reference point is connected to or fixed to the wall of the container.

3. The device according to claim 1, wherein the location of the reference point is predetermined.

4. The device according to claim 1, wherein the reference point is located at the vertical height of the bottom of the wall of the container.

5. The device according to claim 1, wherein the reference point is located at the vertical height of the top of the wall of the container.

6. The device according to claim 1, wherein the reference point is located at the vertical height at substantially the bottom or top of the wall of the container.

7. The device according to claim 1, wherein the reference point is located on the ground.

8. The device according to claim 1, wherein the reference point is located at a point between the bottom of the wall of the container and the ground.

9. The device according to claim 1, wherein the power storage source is a battery.

10. The device according to claim 9, wherein the battery is a rechargeable battery.

11. A method for determining the height of a material in a rigid-walled container from the outside of the container without accessing the interior of the container, the method comprising the steps of:
(a) providing a hand-held detection device, wherein the detection device comprises:
(i) means for detecting, through the wall of the container, the presence or absence of the material inside the container adjacent to the detector;
(ii) means for generating a first output corresponding to the presence or absence of the material inside the container adjacent to the detector, whereby the location of the surface level of the material inside the container can be determined through the wall of the container by moving the device and observing the first output;
(iii) means for measuring the vertical distance between the surface level of the material and a reference point associated with the container;
(iv) means for generating a second output corresponding to the vertical distance between the surface level of the material and the reference point; and
(v) a power storage source;
(b) positioning the detection device on the outside of the wall of the container adjacent to the surface level of the material; and
(c) determining the height of the material contained in the container by using the second output.

12. The method according to claim 11, wherein the device is positioned on the outside of the wall of the container using hand pressure.

13. The method according to claim 11, wherein the device is positioned adjacent to the surface level of the material by first positioning the device at a specific location on the outside of the wall of the container and observing the first output for determining the presence or absence of the material, and then vertically moving the device along the outside of the wall of the container until the first output changes from indicating an absence of the material to indicating a presence of the material.

14. The method according to claim 11, further comprising the step of maintaining the device at the surface level of the material until the step of determining the height of the material can be determined.

15. The method according to claim 11, wherein the reference point is located at the vertical height of the bottom of the wall of the container.

16. The method according to claim 15, wherein the step of determining the height of the material comprises reading the output for the second output.

17. The method according to claim 11, wherein the reference point is located at the vertical height of the top of the wall of the container.

18. The method according to claim 17, wherein the step of determining the height of the material comprises the step of subtracting the second output from the total height of the container.

19. The method according to claim 11, further comprising the step of calculating the volume of the material in the container after the step of determining the height of the material in the container.

20. The method according to claim 19, wherein the step of calculating the volume includes the height of the material and the specific dimensions of the container.
